(19) United States
(12) Patent Application Publication
(10) Pub. No.: US 2013/0272393 A1
(43) Pub. Date: Oct. 17, 2013

(54) VIDEO CODING AND DECODING DEVICES AND METHODS PRESERVING PPG RELEVANT INFORMATION

(71) Applicants: Ihor Olehovych Kirenko, Eindhoven (NL); Gerard De Haan, Helmond (NL); Adriaan Johan Van Leest, Eindhoven (NL); Pavlo Serhiyovych Mulyar, Eindhoven (NL)

(72) Inventors: Ihor Olehovych Kirenko, Eindhoven (NL); Gerard De Haan, Helmond (NL); Adriaan Johan Van Leest, Eindhoven (NL); Pavlo Serhiyovych Mulyar, Eindhoven (NL)

(73) Assignee: KONINKLIJKE PHILIPS N.V., Eindhoven (NL)

(21) Appl. No.: 13/993,699

(22) PCT Filed: Dec. 21, 2011
(86) PCT No.: PCT/IB2011/055847

§ 371 Date: Jun. 13, 2013

(30) Foreign Application Priority Data
Jan. 5, 2011 (EP) 11150149.0

(51) Int. Cl. H04N 7/26

(52) U.S. Cl. CPC H04N 19/004
USPC 375/240.08

(57) ABSTRACT

The present invention relates to a video encoding device (10) for encoding video data and a corresponding video decoding device, wherein during decoding PPG relevant information shall be preserved. For this purpose the video coding device (10) comprises a first encoder (20) for encoding input video data (100) according to a first encoding scheme and outputting first coded video data (120) having a lower quality than the input video data, and a second encoder (30) for encoding input video data (100) according to a second encoding scheme preserving PPG-relevant information and outputting second coded video data (130).

### FIELD OF THE INVENTION

The present invention relates to a video encoding device and a corresponding video encoding method for encoding video data, by which PPG (photo plethysmographic imaging) relevant information is preserved.

Further, the present invention relates to a video decoding device and a corresponding video decoding method for decoding encoded video data.

Still further, the present invention relates to a video coding system for encoding and decoding video data and to a computer program for implementing said methods.

### BACKGROUND OF THE INVENTION

There is an increasing demand to provide technological solutions for a robust continuous monitoring of biometrical signals of people. This demand is a result of growing awareness of the importance of a healthy and active lifestyle among the younger generations. Moreover, the constantly ageing population as a result of increased life expectancy puts extra pressure on the necessity of health monitoring systems with minimal interference to a person's daily life activity. Unobtrusive monitoring of biometrical signals could be used to provide a virtually immediate feedback on the body and mind condition at any time, and evaluate changes in the health status of people as soon as possible.

Conventional devices and methods of measuring biometrical signals (e.g. heart rate, respiratory rate, blood pressure, skin oxygenation, etc) require the user to wear annoying body sensors, which might be experienced as obtrusive to a normal human life activity. Therefore, attempts are seen in recent years to develop contactless techniques for remote monitoring of vital body signals. The latest developments show the implementation of unobtrusive remote monitoring by means of imaging sensors as designed for consumer (webcam) or broadcast video.

A method to measure skin color variations, called Photo-Plethysmographic imaging (PPG), is described in Wim Verkruysse, Lars O. Svaasand, and J. Stuart Nelson, “Remote plethysmographic imaging using ambient light”, Optics Express, Vol. 16, No. 26, December 2008. It is based on the principle that temporal variations in blood volume in the skin lead to variations in light absorptions by the skin. Such variations can be registered by a video camera that takes images of a skin area, e.g. the face, while processing calculates the pixel average over a manually selected region (typically part of the cheek in this system). By looking at periodic variations of this average signal, the heart beat rate and respiratory rate can be extracted.

Known systems for remote measurement of heart beat or respiratory rate signals are based on analysis of uncompressed, un-processed video sequences directly after image sensing. In most “real-life” applications video sequences are stored or transmitted in a compressed form. The compression of video signals presumes a removal of some redundant (from visual perception point of view) information. Unfortunately, information, which is not important for visual perception might be crucial for detection of biometrical signals. For instance, the MPEG compression standard makes use of inter-frame predictions, which slightly changes the temporal information of a video signal. Those changes make the detection of temporal biometrical signals difficult or even impossible. However, for many applications, extraction of heart beat signal from a video should be implemented after the video recording took place. In those cases, compressed video would be processed.

The PPG relevant information can be preserved in a coded bit stream if a video is compressed at a high bit rate. However, compression of a video with a low compression ratio will increase the size of a storage file or increase the transmission bandwidth.

Therefore, there is a need for preservation of the information required for off-line extraction of biometrical signals during video recording and compression, in particular according to one of the conventional video coding standards.

### SUMMARY OF THE INVENTION

It is an object of the present invention to provide a video encoding device and a corresponding video encoding method for encoding video data, by which PPG relevant information is preserved without requiring a large amount of additional data. It is a further object of the present invention to provide a corresponding video decoding device and method, a video coding system and a computer program for implementing said methods.

In a first aspect of the present invention a video encoding device is presented comprising
i) a first encoder for encoding input video data according to a first encoding scheme and outputting first coded video data having a lower quality than the input video data,
ii) a second encoder for encoding input video data according to a second encoding scheme preserving PPG-relevant information and outputting second coded video data, said second encoding unit comprising:
   a decoding unit for decoding said first coded video data, in particular according to a decoding scheme complementary to said first encoding scheme, and outputting intermediate video data,
   a subtraction unit for forming difference video data by determining the difference between said intermediate video data and said input video data,
   a selection unit for selecting a region of interest in said difference video data providing a strong PPG signal, and
   an encoding unit for encoding said selected region of interest of said difference video data and outputting it as said second coded video data.

In a further aspect of the present invention a video decoding device is presented for decoding encoded video data, said encoded video data comprising first coded video data encoded according to a first encoding scheme and having a lower quality than input video data and comprising second coded video data encoded according to a second encoding scheme preserving PPG-relevant information, said video decoding device comprising:
i) a first decoder for decoding said first coded video data according to a first decoding scheme and outputting first decoded video data,
ii) a second decoder for decoding said second coded video data according to a second encoding scheme and outputting a PPG signal, said second decoding unit comprising:
   a decoding unit for decoding said second coded video data, in particular according to a decoding scheme complementary to an encoding scheme used in the second encoding scheme used for encoding said input video data, for retrieving an ROI information about the location of a selected region of interest in the first coded video data, and outputting second decoded video data and said ROI information,
   an addition unit for forming a summation video data by adding said second decoded video data to said first decoded video data,
   a selection unit for selecting a region of interest in said summation video data by use of said ROI information, said region of interest providing a strong PPG signal, and
   a PPG extraction unit for extracting of said PPG signal from said selected region of interest in said summation video data.

In further aspects of the present invention a corresponding video coding method and a corresponding video decoding method, a video coding system and a computer program comprising program code means for causing a computer to carry out the steps of the proposed method when said computer program is carried out on the computer are presented.

Preferred embodiments of the invention are defined in the dependent claims. It shall be understood that the claimed video decoding device, video coding system, methods and computer program have similar and/or identical preferred embodiments as the claimed video coding device and as defined in the dependent claims.

The present invention seeks to preserve PPG visual information during a video compression, e.g. by a standard video coder, while allowing compression at a low bit rate.

Preferably, the invention allows the generation of a standard compliant coded bit stream. It is particularly proposed to compress a video stream with at least two layers, where one of the layers (hereinafter also called enhancement layer which corresponds to the output of the second encoding unit in the proposed video encoding device) will contain additional information enabling the extraction of PPG signals from the decoded video, while other layer(s) (hereinafter also called base layer(s) which correspond(s) to the output of the first encoding unit in the proposed video encoding device) will contain the video encoded/compressed, e.g. in a regular fashion, i.e. optimal from a perception point of view.

The base layer(s) thus comprises first coded video data having a lower quality than input video data. Generally, said lower quality is a lower visual quality, but the first encoding, e.g. including a data compression, does not necessarily lead to a visual degradation. It could also happen that the PPG relevant information is destroyed or impaired without a loss of visual quality by the first encoding, i.e. a viewer does not necessarily see any visual difference between the input video data and the first coded video data, although PPG relevant information has been lost due to the encoding.

The proposed invention is based on the idea to detect PPG essential visual information, in particular based on an analysis of an original video sequence, to perform regular encoding and decoding of the video sequence in a base layer, and to generate an enhancement layer containing (possibly compressed) additional information to enable a more accurate representation of the visual information relevant for PPG extraction based on the aforementioned detection. Particularly an area that provides a strong PPG signal (preferably the strongest PPG signal), i.e. from which a PPG signal can be well extracted, is selected for encoding into said enhancement layer. Finally, the base layer and the enhancement layer(s), i.e. the first coded video data and the second video data, may be combined in a single encoded video stream for storage on a data carrier or transmission over a transmission line, e.g. the internet or through a mobile communications system.

In this context the expression “PPG-relevant information” is to be understood as information that is relevant for obtaining a PGG signal. Such PPG-relevant information may include information contained in original video data that is not recognized for the human eye, for instance slight color changes of the skin of a person. The expression “PPG signal” in this context generally means any signal that can be obtained through PhotoPlethysmoGraphy analysis, such as temporal biometrical signals, e.g. the heartbeat, cardiac cycle, respiratory rate, SpO2, depth of anesthesia or hypo- and hypervolemia.

In a preferred embodiment, the proposed video encoding device further comprises an analysis unit for analyzing said input video data and determining a region of interest providing a strong PPG signal, and providing a ROI information about the location of said region of interest to said selection unit for selecting said region of interest in said difference video data. Generally, the selection unit is adapted for selection of a desired region of interest or for getting an information, e.g. through a user interface or from any earlier selection, which region to use as region of interest. In a preferred embodiment a separate analysis unit is provided. Such an analysis unit may, for instance, comprise a face and/or a skin detector for detecting face and/or skin regions in the video data, in particular in one or more image frames. Preferably, the most stable face and/or skin region is selected as region of interest, and the selection unit is provided with an information about the location of said region of interest, hereinafter called ROI information. Such a detector is, for instance, described in Paul Viola, Michael Jones, “Robust Real-time Object Detection”, 2^{nd} Intern.

Workshop on Statistical and Computational Theories of Vision, Vancouver, Canada, 2001.

Preferably, in an embodiment the encoding unit is adapted for encoding not only the selected region of interest in said difference video data, but also additional regions for the complete difference video data. This provides that during decoding in a video decoding device not only the PPG signal and the original video data (with low visual quality according to the used first encoding scheme) can be obtained, but also video data with improved visual quality can be obtained from said encoded additional regions or the encoded complete difference video data.

For instance, in an embodiment, it may be desired that a particular region of an image is not only provided with low quality after decoding but with higher quality, such as a face of a person. This region may then be selected as additional region that is separately encoded in the video encoding device into the second coded video data so that in the video decoding device said additional region can be decoded with a higher image quality than the first coded video data.

According to another embodiment the subtraction unit is adapted for forming said difference video data by determining the pixel-based difference between a video frame of said intermediate video data and a corresponding video frame of said input video data.

Thus, while generally also block-based differences, i.e. differences between groups of pixels, could be used for forming the difference video data, a pixel-based difference provides the highest accuracy. Preferably, this is done frame by frame, which also holds for other steps of the proposed method and device.

Advantageously, the selection unit is adapted for selecting at least the chrominance components, in particular only the chrominance components, of said region of said interest in said difference video data and the encoding unit is adapted for encoding at least said chrominance components, in particular only said chrominance components, of the selected region of interest in said difference video data. This contributes to a reduction of the amount of data contained in the second coded video data which is one of the objects to be achieved according to the present invention. Generally, however, not only chrominance components but also luminance components may be selected and encoded requiring, however, more storage space for the second coded video data. If, however, the purpose of providing the second coded video data is only to enable the video decoding device to retrieve a PPG signal such luminance components are generally not required.

In another embodiment the encoding unit is adapted for encoding only DC components of inter- or intra-blocks of at least the chrominance components, in particular only the chrominance components, of said selected region of interest in said video data. This further contributes to a reduction of the amount of a second coded video data. The PPG relevant information is generally carried by all pixels, but there is generally not much interest in the spatial information. Instead, only as many pixels are needed to take an average in order to improve the signal-to-noise-ratio of the desired PPG signal, e.g. heartbeat, in the individual pixels. The PPG relevant information/the PPG signal is usually smaller even than the quantization steps of an uncompressed 8 bit video signal. This average can be based on the DC component, and there is no absolute need to know the individual pixel values, although it could help in blocks that contain skin and some other image parts (e.g. at the boundary of a face).

In another embodiment the encoding unit is adapted for encoding in or adding to the second coded video data an ROI information about the location of the selected region of interest in the input video data. While it is generally possible that the video decoding device can find a location of the selected region of interest through image analysis, in a preferred embodiment a corresponding ROI information is additionally encoded which can be read and used by the video decoding device.

Still further, in an embodiment the selection unit is adapted for selecting two or more regions of interest in such difference video data providing strong PPG signals, and the encoding unit is adapted for encoding the selected regions of interest of said difference video data and outputting them as said second coded video data. Thus, not only a single region of interest but several regions of interest are available for evaluation and retrieval of PPG signals during decoding which increases the reliability. For instance, in an embodiment PPG signals may be retrieved from each of said regions of interest and thereafter in evaluation which of the PPG signal as the highest reliability or an averaging of all PPG signals may be carried out.

During decoding, the video decoding devices are at least able for extract a PPG signal from the combination of first and second coded video data. The PPG extraction uses, for this purpose, generally known methods as, for instance, described in the above-mentioned paper about PPG imaging or as described in other citations describing the basics of PPG. In a preferred embodiment of the video decoding device, however, also enhanced (higher quality) video data of additional regions or of the complete input video data may be retrieved in case corresponding data are included in the second coded video data as explained above.

### BRIEF DESCRIPTION OF THE DRAWINGS

These and other aspects of the invention will be apparent from and elucidated with reference to the embodiment(s) described hereinafter. In the following drawings

FIG. 1 shows a schematic block diagram of a first embodiment of a video encoding device according to the present invention,

FIG. 2 shows a schematic block diagram of a first embodiment of a video decoding device according to the present invention,

FIG. 3 shows a schematic block diagram of a second embodiment of a video encoding device according to the present invention,

FIG. 4 shows a schematic block diagram of a second embodiment of a video decoding device according to the present invention, and

FIG. 5 shows a schematic block diagram of a third embodiment of a video encoding device according to the present invention.

### DETAILED DESCRIPTION OF THE INVENTION

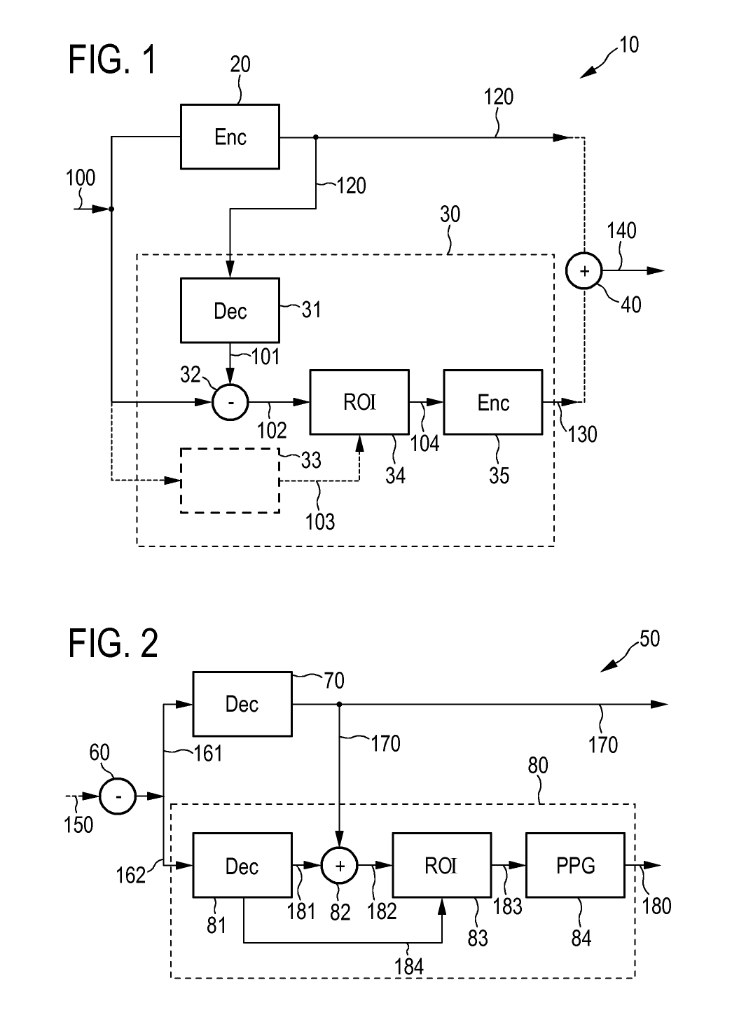

FIG. 1 shows a schematic block diagram of a first embodiment of a video encoding device 10 according to the present invention. According to this embodiment an original video stream 100, also called input video data, is compressed by a first (e.g. standard) encoder 20 at a low bit rate (or at least a bit rate which may be optimal for perception but not sufficient for PPG-extraction), thus forming a base layer video stream 120, also called first coded video data herein. This base layer video stream 120 generally contains video data with a quality at which PPG related information is destroyed. Encoding and transmission of PPG related information is done by means of enhancement layer, which contains the PPG related information, which is removed or corrupted in the base layer video stream 120.

Generally, the PPG signal can be extracted only from skin areas. Moreover, the quality of PPG signals depends on the certain properties of these skin areas, for instance temporal stability, level of illumination and size. Therefore, not the entire skin area will equally contribute to the PPG signal.

In a second encoder 30, applying a second encoding scheme provided for preserving PPG relevant information after encoding, the base layer video stream 120 is first decoded in a decoding unit 31, preferably according to a decoding scheme complementary to the first encoding scheme used for encoding by the first encoder 20, and an intermediate video stream (intermediate video data) 101 is output from the decoding unit 31.

In a subtraction unit 32 a difference video stream 102 (difference video data) is formed by determining the difference between said intermediate video stream 101 and said input video stream 100.

In general, differences between the original video stream 100 and decoded base layer frames 101 in both luminance and chrominance components can be encoded in an enhancement layer video stream 130. However, in case the enhancement layer video stream 130 is required only to extract a PPG signal after decoding, then at least (preferably only) chrominance components can be encoded in the enhancement layer video stream 130. Preferably, the enhancement layer video stream 130 is generated as a pixel-based difference between the decoded base layer video stream 101 and original video frames 100.

In an optional analysis unit 33 the original video stream 100 is processed. In particular, the skin areas of a person's skin in one or more image frames is analyzed and a region of interest (ROI) is defined, which provides a strong PPG signal. This analysis unit 33 may, for instance, comprise a conventional face and/or skin detector which searches for the most stable face and/or skin region since such stable regions are generally supposed to provide the strongest PPG signals. The unit 33 can select a smallest ROI, which would be able to provide a PPG signal. The expected strength of a PPG signal can be analyzed either by analyzing a spatial pixel uniformity inside ROI or by detecting a preferred face areas (e.g. forehead, cheeks). The output of analysis unit 33 is an information about the location of the region of interest, e.g. in the form of a ROI information, which is provided to a selection unit 34 for selecting the region of interest in the intermediate video data 102. The selected region of interest of said difference video data 102 is then encoded in an encoding unit 35. Finally, the encoded region of interest is then outputted as second coded video data 130.

The selection unit 34 preferably selects, e.g. based on the provided ROI information 103, as selection signal 104 at least (preferably only) chrominance components of pixels, which would provide the strongest PPG signal. Alternatively, the selection unit 34 may itself analyze the intermediate video data 102 and select an appropriate region of interest, e.g. by use of image analysis means. Still further, in an embodiment not only a single region of interest, but several regions are selected for PPG extraction, in particular for improving the ability to select the best PPG signal or for averaging PPG signals obtained from different regions.

The selected region of interest is generally smaller than the corresponding skin area and contains the minimum number of pixels required for extraction of PPG signals. An encoder, e.g. a standard encoder, encodes the selection signal, i.e. in this embodiment the chrominance components 104 of the selected ROI into the enhancement layer video stream 130. Due to the fact, that the enhancement layer video stream 130 contains a relatively small number of pixels and preferably only chrominance components, this layer can be encoded at a relatively high bit rate, i.e. near lossless, and yet contributes little to the overall bit rate, i.e. require only a small amount of bit rate or storage space compared to the base layer video stream 120.

In general, differences between original and decoded base layer video frames in both luminance and chrominance components can be encoded in the enhancement layer video stream 130. However, in case the enhancement layer video stream 130 is required only to extract the PPG signal after decoding, then at least (preferably only) the chrominance components need to be encoded in the enhancement layer video stream 130. Preferably, the enhancement layer video stream 130 is generated as a pixel-based difference between the decoded base layer and original video frames.

Generally, the base layer video stream 120 and the enhancement layer video stream 130 may be transmitted (e.g. via the internet, a communications network or a broadcast system) and/or stored (e.g. on a record carrier) separately. However, in an embodiment the base layer video stream 120 and the enhancement layer video stream 130 are combined by a combination unit 40 into an encoder output video stream 140 which is stored and/or transmitted. For such a combination multiple options exist and any one of a plurality of known methods for combining two video streams or, more generally, two data streams may be used.

Generally, the base and enhancement layer video streams 120, 130 are encoded using standard encoders, therefore any corresponding standard decoder can decode each of the video streams (bit streams). However, only a video decoding device, which is built according to the proposed scheme, i.e. which is complementary to the scalable video encoding device 10 shown in FIG. 1, can generally be used for decoding and retrieving a PPG signal there from.

A first embodiment of a schematic block diagram of a video decoding device 50 is shown in FIG. 2. By this video decoding device a PPG signal can be reconstructed from the compressed video streams (or the combined video stream).

In particular, if at the input the decoder input video stream 150 is the combined video stream which—apart from disturbances introduced during storage and/or transmission—should correspond to the encoder output video stream 140, in a separation unit 60 the base layer video stream 161 and the enhancement layer video stream 162 are retrieved, which should—correspond to the base layer video stream 120 and the enhancement layer video stream 130.

In a first decoder 70 the base layer video stream 161 (also called first coded video data) is decoded, in particular according to a first decoding scheme that is complementary to the first encoding scheme used by the first encoder 20. The output is the first decoded video data 170 which should correspond to the video data 101.

In a second decoder 80 the enhancement layer video stream 162 (also called second coded video data) is encoded according to a second encoding scheme. The output of the second decoder 80 is a PPG signal 180 providing biometrical information of a person shown in the video data. Thus, in this embodiment the enhancement layer video stream 130 and 162, respectively, is used only to transport video information required to extract PPG signals.

In particular, in a decoder unit 81 preferably only the chrominance components of the ROI are decoded and outputted as second decoded video data 181 thus improving the quality of the video data showing the region of interest. In an addition unit 82 summation video data 182 is formed by adding said second decoded video data 181 to said decoded base layer video stream 170.

A selection unit 83 defines the area(s) (=region(s) of interest) 183, which is (are) improved by the enhancement layer video data 181, and which will be used for the extraction of PPG signal(s). To define such a region of interest, the coordinates of the compressed chrominance blocks are preferably obtained from the first decoder, which has extracted corresponding ROI information 184, e.g. by reading a ROI information included in the enhancement layer video stream 162 or by image analysis.

In a PPG extraction unit 84 a PPG signal extraction algorithm is applied to spatial region(s) of interest 183 selected by the selection unit 83 to obtain one or more PPG signal(s) 180.

The PPG extraction algorithm can be either real-time or non real-time with manual tuning of parameters. Moreover, the present invention generally allows selection of any particular method of biometrical signal extraction after the video data have been recorded, depending on the particular application. Thus, the same video can be used for extraction of different biometrical signals (e.g. heart rate, heart rate variability, SpO2, respiration, PPG imaging).

Thus, the present invention modifies the known concept of SNR or quality scalability during video compression for the purpose of enabling vital signs extraction. In the proposed concept a base layer encoder compresses a video stream at (generally) relatively low visual quality with a loss of PPG essential information, while an enhancement layer encoder compresses one or more regions of interest of the residual video data (obtained as a difference between the original video and decoded base layer) without loss of PPG essential information, rather than with additional resolution as is known from prior art.

The present invention can be used for video streaming a well as for storage of compressed video material. Normally, only a base layer bit stream will be transferred or decompressed to obtain a video data at a basic quality. The enhancement layer with PPG essential information will be transferred or decompressed only if biometrical signals should be extracted from skin areas. In this way, the optimal trade-off between a compression efficiency and preservation of biometrical information in the compressed video can be achieved.

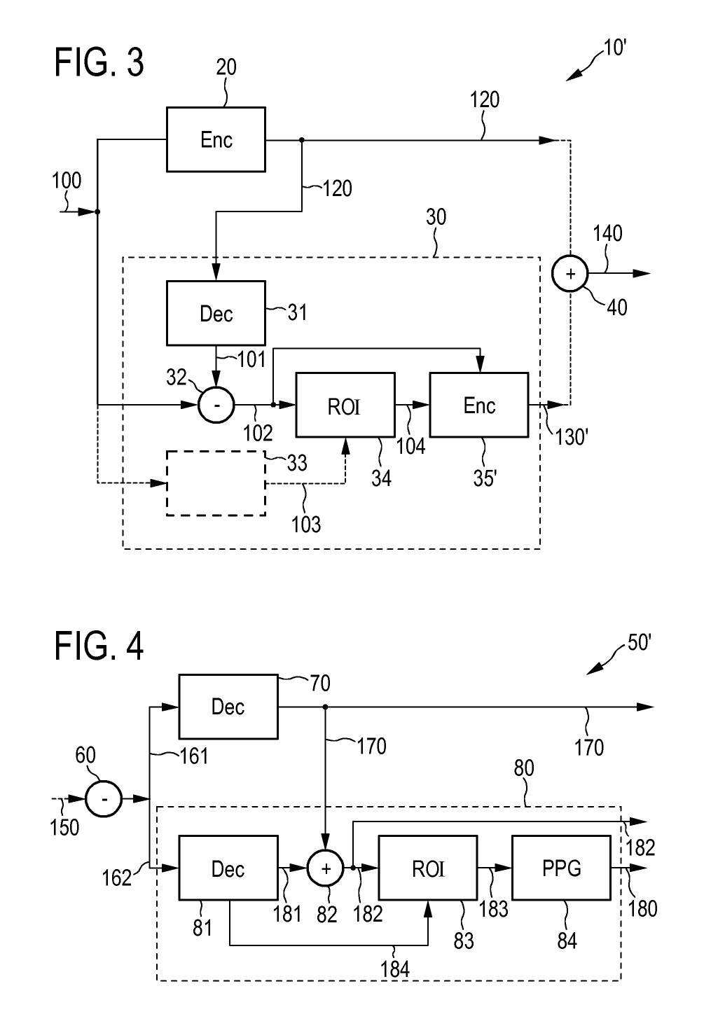

Another embodiment of a video encoding device 10′ and a video decoding device 50′ according to the present invention are shown in FIGS. 3 and 4.

In the embodiment of the video encoding device 10′ the encoding unit 35′ is adapted to include not only chrominance components required for PPG signal extraction into the enhancement layer video stream 130′, but also enhancement information for more (or all) pixels of the video (or of one or more video frames). In this case, the combination 182 of decoded base layer video stream 170 and decoded enhancement layer video stream 181 will provides an enhanced video sequence with improved visual quality, which may be separately issued and used as decoded video data with higher image quality than the decoded base layer video stream 170.

Further, in the embodiment of the video decoding device 50′ the selection unit 83′ may be applied to frames of the enhanced video stream 182 and can select proper areas for PPG signal extraction either independently, or based on a bit-budget information from decoders of base and enhancement layers. In the second case, skin blocks with higher bit-budget (i.e. more bits) spent on chrominance components, and/or intra-block encoded will be selected to be optimal for PPG signal extraction.

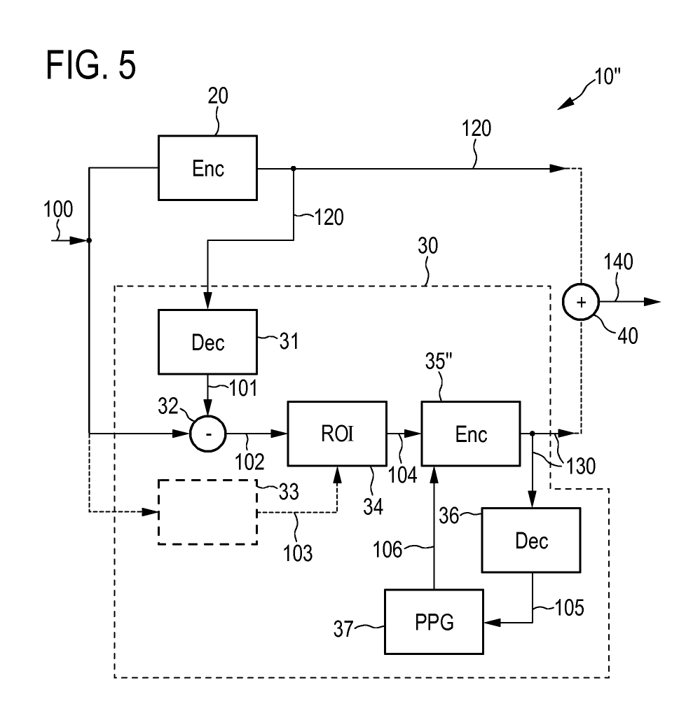

Still another embodiment of a video encoding device 10″ according to the present invention is schematically depicted in FIG. 5. This embodiment is quite similar to the embodiment of the video encoding device 10 shown in FIG. 1, but in addition a decoding unit 36 and a PPG signal extraction unit 37 are provided in a feedback loop formed with the encoding unit 35″. This feedback loop controls the number of bits allocated to the selected region of interest 104, i.e. controls the setting of the encoding used for encoding said selected region of interest 104 to make sure that the PPG-relevant information is preserved in the encoded region of interest 130.

Thus, the decoding unit 36 decodes the encoded region of interest 104 (applying a decoding scheme that is complementary to the first encoding scheme applied by the first encoding unit 30″) and the PPG signal extraction unit 37 extracts a PPG signal 106 from the decoded region of interest 105. The first encoding unit 30″ can then decide if the

PPG signal has sufficient quality or if the setting used for encoding needs to be changed (e.g. if more bits need to be assigned for the encoded region of interest, and/or if the compression rate needs to be lowered) to increase the quality of the extracted PPG signal. Thus, it can be ensured that in a decoding device a PPG signal can be extracted with sufficient quality.

In summary, the proposed invention allows extraction of the PPG signal after video (de-)compression. The type, complexity and accuracy of PPG extraction algorithms as well as a type of PPG signal (e.g. heart rate, heart rate variability, SpO2) can be selected based on the concrete application. For instance, some applications may require extraction of only heart rate information, while others may require beat-to-beat precise heartbeat signal, or/and respiration, or/and SpO2 (oxygenation). Moreover, the present invention allows an off-line (non-real-time) extraction of PPG signals from a compressed video, with the possibility to manually select and tune optimal parameters.

Generally, the invention is not restricted to particular encoding/decoding schemes. Generally, the first encoding scheme is more loosely than the second encoding scheme. The encoding performed by the encoding unit of the second encoder may, for instance, use an intra-block and/or inter-block coding technique. For instance, in an embodiment at least DC components of intra- or inter-blocks of chrominance channels associated with selected image areas (regions of interest) of the enhancement layer are encoded lossless.

Further, in an embodiment an in-loop de-blocking filter is switched off for at least the chrominance components of the selected image areas (and possibly their neighboring blocks). Some of standard video coding algorithms apply a processing to video being encoded in order to reduce the level of noise, coding artifacts (by means of de-blocking filter) or to optimize a trade-off of a quality versus bit rate by spatially downscaling video. In an embodiment of the invention, such processing is not applied to at least chrominance components of the selected image areas in the second encoding scheme.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Video encoding device for encoding video data comprising:
i) a first encoder for encoding input video data according to a first encoding scheme and outputting first coded video data having a lower quality than the input video data,
ii) a second encoder for encoding input video data according to a second encoding scheme preserving PPG-relevant information and outputting second coded video data, said second encoding unit comprising:
a decoding unit for decoding said first coded video data, in particular according to a decoding scheme complementary to said first encoding scheme, and outputting intermediate video data,
a subtraction unit for forming difference video data by determining the difference between said intermediate video data and said input video data,
a selection unit for selecting a region of interest in said difference video data providing the strongest PPG signal, and
an encoding unit for encoding said selected region of interest of said difference video data and outputting it as said second coded video data.

2. Video encoding device as claimed in claim 1,
further comprising an analysis unit for analyzing said input video data and determining a region of interest providing the strongest PPG signal and providing a ROI information about the location of said region of interest to said selection unit for selecting said region of interest in said difference video data.

3. Video encoding device as claimed in claim 1,
wherein said encoding unit is adapted for encoding not only the selected region of interest in said difference video data, but also additional regions or the complete difference video data.

4. Video encoding device as claimed in claim 1,
wherein said subtraction unit is adapted for forming said difference video data by determining the pixel-based difference between a video frame of said intermediate video data and the corresponding video frame of said input video data.

5. Video encoding device as claimed in claim 1,
wherein said selection unit is adapted for selecting at least the chrominance components, in particular only the chrominance components, of said region of interest in said difference video data and
wherein said encoding unit is adapted for encoding at least said chrominance components, in particular only said chrominance components, of said selected region of interest in said difference video data.

6. Video encoding device as claimed in claim 1,
wherein said encoding unit is adapted for encoding only DC components of inter- or intra-blocks of at least the chrominance components, in particular only the chrominance components, of said selected region of interest in said difference video data.

7. Video encoding device as claimed in claim 1,
wherein said encoding unit is adapted for encoding in or adding to the second coded video data a ROI information about the location of the selected region of interest in the input video data.

8. Video encoding device as claimed in claim 1,
wherein said selection unit is adapted for selecting two or more regions of interest in said difference video data providing the strongest PPG signals, and
wherein said encoding unit is adapted for encoding said selected regions of interest of said difference video data and outputting them as said second coded video data.

9. Video encoding method for encoding video data comprising the steps of:
encoding input video data (100) according to a first encoding scheme and outputting first coded video data having a lower quality than the input video data,
decoding said first coded video data, in particular according to a decoding scheme complementary to said first encoding scheme, and outputting intermediate video data,
forming difference video data by determining the difference between said intermediate video data and said input video data,
selecting a region of interest in said difference video data providing the strongest PPG signal, and
encoding said selected region of interest of said difference video data and outputting it as second coded video data preserving PPG-relevant information.

10. Video decoding device for decoding encoded video data, said encoded video data comprising first coded video data encoded according to a first encoding scheme and having a lower quality than input video data and comprising second coded video data encoded according to a second encoding scheme preserving PPG-relevant information, said video decoding device comprising:
i) a first decoder for decoding said first coded video data according to a first decoding scheme and outputting first decoded video data,
ii) a second decoder for decoding said second coded video data according to a second encoding scheme and outputting a PPG signal, said second decoding unit comprising:
a decoding unit for decoding said second coded video data, in particular according to a decoding scheme complementary to an encoding scheme used in the second encoding scheme used for encoding said input video data, for retrieving an ROI information about the location of a selected region of interest in the first coded video data, and outputting second decoded video data and said ROI information,
an addition unit for forming a summation video data by adding said second decoded video data to said first decoded video data,
a selection unit for selecting a region of interest in said summation video data by use of said ROI information, said region of interest providing the strongest PPG signal, and
a PPG extraction unit for extracting of said PPG signal from said selected region of interest in said summation video data.

11. Video decoding device as claimed in claim 10,
wherein said decoding unit is adapted for decoding at least chrominance components, in particular only chrominance components, of said second coded video data.

12. Video decoding device as claimed in claim 10,
wherein said decoding unit is adapted for decoding second coded video data comprising not only coded video data of a selected region of interest but also coded video data of additional regions or the complete input video data.

13. Video decoding method for decoding encoded video data, said encoded video data comprising first coded video data encoded according to a first encoding scheme and having a lower quality than input video data and comprising second coded video data encoded according to a second encoding scheme preserving PPG-relevant information, said video decoding method comprising the steps of:
decoding said first coded video data according to a first decoding scheme and outputting first decoded video data,
decoding said second coded video data, in particular according to a decoding scheme complementary to an encoding scheme used in the second encoding scheme used for encoding said input video data, for retrieving an ROI information about the location of a selected region of interest in the first coded video data, and outputting second decoded video data and said ROI information,
forming a summation video data by adding said second decoded video data to said first decoded video data,
selecting a region of interest in said summation video data by use of said ROI information, said region of interest providing the strongest PPG signal, and
extracting of said PPG signal from said selected region of interest in said summation video data.

14. Video coding system for encoding and decoding video data, comprising:
a video encoding device as claimed in claim 1 for encoding input video data, and
a video decoding device for decoding encoded video data, said encoded video data comprising first coded video data encoded according to a first encoding scheme and having a lower quality than input video data and comprising second coded video data encoded according to a second encoding scheme preserving PPG-relevant information, said video decoding device comprising:
i) a first decoder for decoding said first coded video data according to a first decoding scheme and outputting first decoded video data,
ii) a second decoder for decoding said second coded video data according to a second encoding scheme and outputting a PPG signal, said second decoding unit comprising:
a decoding unit for decoding said second coded video data, in particular according to a decoding scheme complementary to an encoding scheme used in the second encoding scheme used for encoding said input video data, for retrieving an ROI information about the location of a selected region of interest in the first coded video data, and outputting second decoded video data and said ROI information,
an addition unit for forming a summation video data by adding said second decoded video data to said first decoded video data,
a selection unit for selecting a region of interest in said summation video data by use of said ROI information, said region of interest providing the strongest PPG signal, and
a PPG extraction unit for extracting of said PPG signal from said selected region of interest in said summation video data.

15. Computer program comprising program code means for causing a computer to carry out the steps of the method as claimed in claim 9 when said computer program is carried out on the computer.
